(19) United States
(12) Patent Application Publication
(10) Pub. No.: US 2007/0252565 A1
(43) Pub. Date: Nov. 1, 2007

(54) INRUSH CURRENT LIMITING CIRCUIT AND POWER SUPPLY DEVICE USING THE SAME

(75) Inventors: Sin-Shong Wang, Tu-Cheng (TW); Shun-Chen Yang, Tu-Cheng (TW); Kuo-Wei Chiang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,191

(22) Filed: Nov. 3, 2006

(30) Foreign Application Priority Data
Apr. 28, 2006 (TW) 095115284

(51) Int. Cl. G05F 1/573

(52) U.S. Cl. 323/277

(57) ABSTRACT

An inrush current limiting circuit (12) includes a transistor (Q), a switch element (M), and a short-circuit protection circuit (121). An emitter of the transistor is as an input of the inrush current limiting circuit. An input of the switch element is connected to a collector of the transistor. A second output of the switch element is as an output of the inrush current limiting circuit. A first terminal of the short-circuit protection circuit is connected to a first output of the switch element. A second terminal of the short-circuit protection circuit is connected to a base of the transistor. A third terminal of the short-circuit protection circuit is connected to the second output of the switch element.

### BACKGROUND OF THE INVENTION

1. Field of the Invention

The present invention relates to inrush current limiting circuits, and particularly to an inrush current limiting circuit with a short-circuit protection circuit and a power supply device using the same.

2. Description of Related Art

Generally, with the development of technologies, network devices, such as asymmetrical digital subscriber loop (ADSL) modems, cable modems, and set-top boxes are widely used. Each of the network devices has a power supply device, for converting an alternating current (e.g., 220V in China or Europe, and 110V in USA) signal to an appropriate direct current signal to ensure normal operation of the network devices. However, when the power supply device is initially powered on, an inrush current is generated due to a capacitance effect. Peak value of the inrush current is relatively high, which can damage components, such as fuses, switches, so that the lifetime of the components under impact of the inrush current is shortened.

### SUMMARY OF THE INVENTION

An inrush current limiting circuit is provided. The inrush current limiting circuit includes a transistor, a switch element, and a short-circuit protection circuit. The transistor has an emitter as an input of the inrush current limiting circuit. The switch element has an input, a first output, and a second output. The input of the switch element is connected to a collector of the transistor. The second output of the switch element is an output of the inrush current limiting circuit. The short-circuit protection circuit has a first terminal, a second terminal, and a third terminal. The first terminal of the short-circuit protection circuit is connected to the first output of the switch element. The second terminal of the short-circuit protection circuit is connected to a base of the transistor. The third terminal of the short-circuit protection circuit is connected to the second output of the switch element.

A power supply device converting received power signals to direct current signals to ensure a load to work normally is provided. The power supply device includes a transformer circuit, a rectifier and filter circuit, and an inrush current limiting circuit. The transformer circuit steps down the received power signals. The rectifier and filter circuit is connected to the transformer circuit, and converts the stepped down signals output from the transformer circuit to direct current signals. The inrush current limiting circuit is connected to the rectifier and filter circuit, for limiting inrush current from the power supply device and providing short-circuit protection function to the load. The inrush current limiting circuit includes a transistor, a switch element and a short-circuit protection circuit. The transistor has an emitter as an input of the inrush current limiting circuit. The switch element has an input, a first output, and a second output. The input of the switch element is connected to a collector of the transistor. The second output of the switch element is as an output of the inrush current limiting circuit. The short-circuit protection circuit has a first terminal, a second terminal, and a third terminal. The first terminal of the short-circuit protection circuit is connected to the first output of the switch element. The second terminal of the short-circuit protection circuit is connected to a base of the transistor. The third terminal of the short-circuit protection circuit is connected to the second output of the switch element.

An inrush current limiting circuit is provided. The inrush current limiting circuit includes a transistor, a switch element and a short-circuit protection circuit. The transistor has an emitter as an input of the inrush current limiting circuit. The switch element has an input, a first output, and a second output. The input of the switch element is connected to a collector of the transistor. The second output of the switch element is as an output of the inrush current limiting circuit. The short-circuit protection circuit has a dividing circuit and a delay circuit; wherein the dividing circuit is for accelerating turn-on time of the transistor.

Other advantages and novel features will become more apparent from the following detailed description when taken in conjunction with the accompanying drawings, in which:

### BRIEF DESCRIPTION OF THE DRAWINGS

FIG. 1 is a circuit diagram of a power supply device of an exemplary embodiment of the present invention; and

FIG. 2 is a detail circuit diagram of an inrush current limiting circuit of FIG. 1.

### DETAILED DESCRIPTION OF THE INVENTION

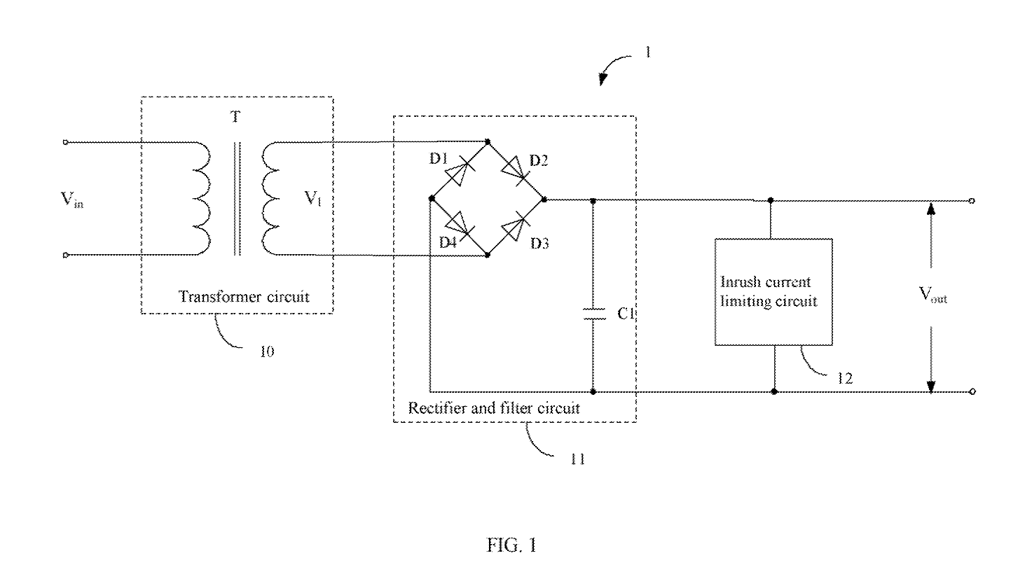

FIG. 1 is a circuit diagram of a power supply device 1 of an exemplary embodiment of the present invention. The power supply device 1 includes a transformer circuit 10, a rectifier and filter circuit 11, and an inrush current limiting circuit 12.

The transformer circuit 10 receives and steps down power signals Vᵢₙ. In the exemplary embodiment, the power signals Vᵢₙ are sine-wave signals output from an alternating current (AC) power source (e.g., 220V in China and Europe, or 110V in USA, not shown in FIG. 1). The rectifier and filter circuit 11 is connected to the transformer circuit 10, and converts the stepped down signals output from the transformer circuit 10 to direct current (DC) signals. The inrush current limiting current 12 is connected to the rectifier and filter circuit 11, for limiting inrush current from the power supply device 1, and outputting DC signals Vₒᵤₜ to a load (not shown in FIG. 1). In the exemplary embodiment, the load can be an ADSL modem, a cable modem, a set-top box, and so on. The inrush current limiting circuit 12 not only limits the inrush current from the power supply device 1, but also has a short-circuit protection function to protect the load.

The transformer circuit 10 includes a transformer T, which includes a primary winding and a secondary winding. The primary winding is for receiving the power signals Vᵢₙ from the AC power source. The secondary winding is connected to the rectifier and filter circuit 11. In the exemplary embodiment, a coil number of the secondary winding is less than that of the primary winding, and low voltage signals V1 are output to the rectifier and filter circuit 11.

The rectifier and filter circuit 11 includes a filter capacitor C1 and a plurality of diodes D1, D2, D3, and D4. A cathode of the diode D1 and an anode of the diode D2 are jointly connected to a high voltage terminal of the secondary winding of the transformer T. An anode of the diode D3 and a cathode of the diode D4 are jointly connected to a low voltage terminal of the secondary winding of the transformer T. A cathode of the diode D2 is connected to a cathode of the diode D3, and an anode of the diode D1 is connected to an anode of the diode D4. The filter capacitor C1 is connected between the anode of the diode D1 and the cathode of the diode D2. Therefore, the filter capacitor C1, the diodes D1, D2, D3, and D4 form a full-bridge rectifier and filter circuit. In the exemplary embodiment, the rectifier and filter circuit 11 converts the low voltage signals V1 output from the transformer circuit 10 to DC signals, and outputs the DC signals to the inrush current limiting circuit 12.

In alternative exemplary embodiments of the present invention, the rectifier and filter circuit 11 can be a half-bridge rectifier and filter circuit.

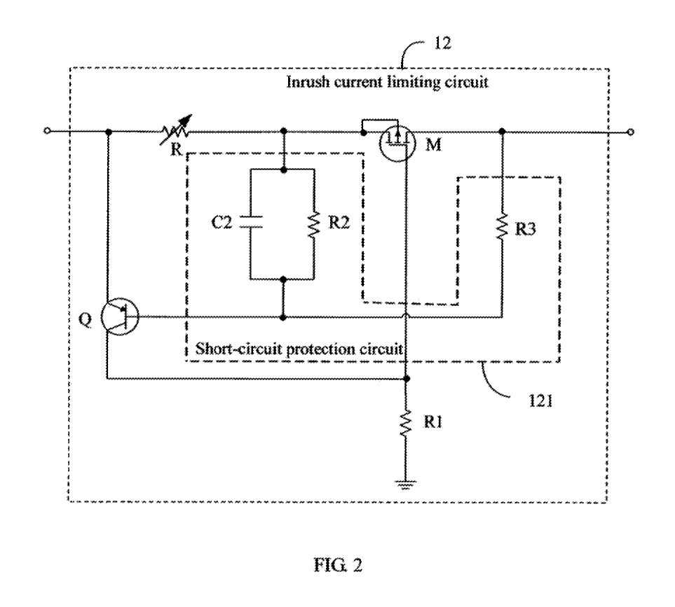

FIG. 2 is a detail circuit diagram of the inrush current limiting circuit 12 of FIG. 1. The inrush current limiting circuit 12 includes a bias resistor R1, a variable resistor R, a transistor, a switch element M, and a short-circuit protection circuit 121. In the exemplary embodiment, the transistor comprises a PNP transistor Q having an emitter as an input of the inrush current limiting circuit 12. The switch element M comprises a metal oxide semiconductor field effect transistor (MOSFET), having a gate as an input, a source as a first output, and a drain as a second output.

The gate of the MOSFET M is connected to a collector of the PNP transistor Q. The drain of the MOSFET M is also an output of the inrush current limiting circuit 12. The short-circuit protection circuit 121 has a first terminal, a second terminal, and a third terminal. The first terminal of the short-circuit protection circuit 121 is connected to the source of the MOSFET M. The second terminal of the short-circuit protection circuit 121 is connected to a base of the PNP transistor Q. The third terminal of the short-circuit protection circuit 121 is connected to the drain of the MOSFET M. The variable resistor R is connected between an emitter of the PNP transistor Q and the source of the MOSFET M, for providing a bias voltage between the base and the emitter of the PNP transistor Q. The bias resistor R1 is connected between the gate of the MOSFET M and ground, for providing another bias voltage to the MOSFET M.

The short-circuit protection circuit 121 includes a capacitor C2 and two transistors R2, R3. The resistor R2 is connected between the first terminal and the second terminal of the short-circuit protection circuit 121. The capacitor C2 is connected to the resistor R2 in parallel. The resistor R3 is connected between the second terminal and the third terminal of the short-circuit protection circuit 121. The resistors R2 and R3 form a dividing circuit for accelerating turn-on time of the PNP transistor Q. The resistor R2 and the capacitor C2 form a delay circuit, for delaying turn-on time of the PNP transistor Q when the load is initially powered up. Namely, the short-circuit protection circuit 121 includes a dividing circuit and a delay circuit.

In the exemplary embodiment, the filter capacitor C1 discharges to the load according to a formula i(t)=V/R′×e^{-t/R′C} (wherein R′ indicates an equivalent impedance of the inrush current limiting circuit 12). At t=0, because the value of resistor R′ is small, and the capacitor C2 acts as a short circuit, the current i(0) flowing through the power supply device 1 approaches infinity, which is inrush current.

At the time inrush current flows, the variable resistor R provides a bias voltage between the base and the emitter of the PNP transistor Q, for example, 0.7V, so that the PNP transistor Q turns on. Then, the PNP transistor Q is saturated. Consequently, the MOSFET M turns off, preventing the inrush current from the power supply device 1 to reach the load.

Once the inrush current settles down to a stable and desirable current level, and voltage on the variable resistor R is less than 0.7V, the PNP transistor Q turns off, and the MOSFET M turns on, allowing power to reach the load.

If a short circuit develops at the load, current flowing through the inrush current limiting circuit 12 of the power supply device 1 increases, causing voltage across the resistor R2 and the bias voltage on the PNP transistor Q to increase as well, which accelerates turn-on time of the PNP transistor Q. Consequently, the PNP transistor Q is immediately saturated after the PNP transistor Q turns on, so that the MOSFET M turns off and current is limited to flow to the load. In the exemplary embodiment, the resistor R2 also protects the PNP transistor Q from too much current flowing thereto.

When the power supply device 1 is initially powered up, a storage capacitor (not shown in FIG. 2) connected to the load in parallel can be regarded as short circuit, current flowing through the inrush current limiting circuit 12 of the power supply device 1 is increased. Due to voltage between the source and the drain of the MOSFET M being dropped, input current in the inrush current limiting circuit 12 is charged to the capacitor C2 and the storage capacitor via the variable resistor R. In the exemplary embodiment, charge time of the capacitor C2 is greater than that of the storage capacitor. That is, when the storage capacitor is charged completely, the capacitor C2 is still charged. When the capacitor C2 is charged, current doesn't flow through the resistor R2, so that the PNP transistor Q turns off. Consequently, when the power supply device 1 provides power to the load initially and the storage capacitor is charged, the PNP transistor Q turns off and the MOSFET M turns on, which ensure the load to work normally.

The inrush current limiting circuit 12 of the present invention having the short-circuit protection circuit 121 with a dividing circuit and a delay circuit uses the variable resistor R to control on/off time of the PNP transistor Q and the MOSFET M, which protects a load from inrush current. As described, the resistors R2 and R3 form the dividing circuit, for accelerating turn-on time of the PNP transistor Q in order to turn the MOSFET M off immediately when the load is short-circuited. Furthermore, the resistor R3 and the capacitor C2 form the delay circuit, for delaying turn-on time of the PNP transistor Q when the load is initially powered up, which ensures normal power to the load.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalent.

What is claimed is:

1. An inrush current limiting circuit, comprising:
a transistor, having an emitter as an input of the inrush current limiting circuit;
a switch element having an input, a first output, and a second output, wherein the input of the switch element is connected to a collector of the transistor, the second output of the switch element is as an output of the inrush current limiting circuit; and
a short-circuit protection circuit, having a first terminal, a second terminal, and a third terminal, wherein the first terminal of the short-circuit protection circuit is connected to the first output of the switch element, the second terminal of the short-circuit protection circuit is connected to a base of the transistor, and the third terminal of the short-circuit protection circuit is connected to the second output of the switch element.

2. The inrush current limiting circuit as claimed in claim 1, wherein the short-circuit protection circuit comprises:
a first resistor, connected between the first terminal and the second terminal of the short-circuit protection circuit; and
a second resistor, connected between the second terminal and the third terminal of the short-circuit protection circuit, wherein the first resistor and the second resistor form a dividing circuit, for accelerating turn-on time of the transistor.

3. The inrush current limiting circuit as claimed in claim 2, wherein the short-circuit protection circuit further comprises a capacitor, connected to the first resistor in parallel, and the capacitor and the second resistor form a delay circuit.

4. The inrush current limiting circuit as claimed in claim 1, further comprising a variable resistor, connected between the emitter of the transistor and the first output of the switch element, for providing a bias voltage between the base and the emitter of the transistor.

5. The inrush current limiting circuit as claimed in claim 1, further comprising a bias resistor, connected between the input of the switch element and ground, for providing another bias voltage to the switch element.

6. A power supply device, for converting received power signals to direct current signals to ensure a load to work normally, comprising:
a transformer circuit, for stepping down the received power signals;
a rectifier and filter circuit, connected to the transformer circuit, for converting the stepped down signals output from the transformer circuit to the direct current signals; and
an inrush current limiting circuit, connected to the rectifier and filter circuit, for limiting inrush current from the power supply device and providing short-circuit protection function to the load, comprising:
a transistor, having an emitter as an input of the inrush current limiting circuit;
a switch element having an input, a first output, and a second output, wherein the input of the switch element is connected to a collector of the transistor, the second output of the switch element is as an output of the inrush current limiting circuit; and
a short-circuit protection circuit, having a first terminal, a second terminal, and a third terminal, wherein the first terminal of the short-circuit protection circuit is connected to the first output of the switch element, the second terminal of the short-circuit protection circuit is connected to a base of the transistor, and the third terminal of the short-circuit protection circuit is connected to the second output of the switch element.

7. The power supply device as claimed in claim 6, wherein the transformer comprises a transformer comprising a primary winding and a secondary winding.

8. The power supply device as claimed in claim 7, wherein the rectifier and filter circuit comprises:
a first diode;
a second diode, wherein an anode of the second diode and a cathode of the first diode are jointly connected to a high voltage terminal of the secondary winding of the transformer;
a third diode, wherein a cathode of the third diode is connected to a cathode of the second diode; and
a fourth diode, wherein a cathode of the fourth diode and an anode of the third diode are jointly connected to a low voltage terminal of the secondary winding of the transformer, and an anode of the fourth diode is connected to an anode of the first diode.

9. The power supply device as claimed in claim 8, further comprising a filter capacitor connected between the anode of the first diode and the cathode of the second diode.

10. The power supply device as claimed in claim 6, wherein the short-circuit protection circuit comprises:
a first resistor, connected between the first terminal and the second terminal of the short-circuit protection circuit; and
a second resistor, connected between the second terminal and the third terminal of the short-circuit protection circuit, wherein the first resistor and the second resistor form a dividing circuit, for accelerating turn-on time of the transistor.

11. The power supply device as claimed in claim 10, wherein the short-circuit protection circuit further comprises a capacitor, connected to the first resistor in parallel, and the capacitor and the second resistor form a delay circuit.

12. The power supply device as claimed in claim 6, further comprising a variable resistor, connected between the emitter of the transistor and the first output of the switch element, for providing a bias voltage between the base and the emitter of the transistor.

13. The power supply device as claimed in claim 6, further comprising a bias resistor, connected between the input of the switch element and the ground, for providing another bias voltage to the switch element.

14. An inrush current limiting circuit, comprising:
a transistor, having an emitter as an input of the inrush current limiting circuit;
a switch element having an input, a first output, and a second output, wherein the input of the switch element is connected to a collector of the transistor, the second output of the switch element is as an output of the inrush current limiting circuit; and
a short-circuit protection circuit, having a dividing circuit and a delay circuit; wherein the dividing circuit is for accelerating turn-on time of the transistor and the delay circuit is for delaying turn-on time of the transistor.

15. The inrush current limiting circuit as claimed in claim 14, wherein dividing circuit comprises:
a first resistor, connected to the first output of the switch element and a base of the transistor; and
a second resistor, connected between the base of the transistor and the second output of the switch element.

16. The inrush current limiting circuit as claimed in claim 15, wherein the delay circuit comprises a capacitor, connected to the first resistor in parallel, the capacitor and the second resistor form the delay circuit.

17. The inrush current limiting circuit as claimed in claim 14, further comprising a variable resistor, connected between the emitter of the transistor and the first output of the switch element, for providing a bias voltage between the base and the emitter of the transistor.

18. The inrush current limiting circuit as claimed in claim 14, further comprising a bias resistor, connected between the input of the switch element and ground, for providing another bias voltage to the switch element.
